(19) United States
(12) Patent Application Publication
(10) Pub. No.: US 2012/0054124 A1
(43) Pub. Date: Mar. 1, 2012

(54) BUILDING ENERGY EFFICIENCY DIAGNOSTIC AND MONITORING SYSTEM

(76) Inventor: Sunil Rodrigues, Somerville, ME (US)

(21) Appl. No.: 13/187,951

(22) Filed: Jul. 21, 2011

(51) Int. Cl. G06F 17/00; G06F 15/00

(52) U.S. Cl. 705/412; 702/136

(57) ABSTRACT

A system and related method are provided to diagnose and/or monitor energy efficiency of a building. The system includes temperature sensors positioned inside and outside the building. For various outside temperatures, the temperature differentials over time at the inside sensors are calculated over selectable time periods, whether for the entire building as a whole or for individual rooms. The temperature differential information is then used to determine energy efficiency of the building, including fuel costs/savings and improvements based on weatherization. The system includes standalone temperature monitoring modules or, alternatively, the system includes temperature monitoring modules that do not retain acquired temperature information but instead transmit that information to a networked device, such as an access point for wireless radio frequency signal transmissions.

### BACKGROUND OF THE INVENTION

1. Field of the Invention

The present invention is in the technical field of data processing. More particularly, the present invention is in the technical field of data acquisition, processing and computing utilized for diagnosing and measuring the loss of the energy used for temperature control in buildings.

2. Description of the Prior Art

Conventionally, energy loss in buildings is detected or diagnosed and tested using a blower door and a thermal imaging camera. The blower door is a calibrated device that is used to identify the overall leakage area of the building and a HVAC (heating, ventilation and air conditioning) duct system if installed. Blower door technology is used in many countries, where energy efficiency is mandated, to measure the air tightness of building envelopes, diagnose and demonstrate air leakage problems, estimate natural infiltration rates, estimate energy efficiency losses from building air leakage, and certify construction integrity. A Blower Door consists of a large fan which is mounted in a frame. The frame is placed in an exterior door and used to either depressurize or pressurize the house. Using the pressure readings, a calculation of the natural leakage of the house air changes per hour natural (achnat) is done.

Thermal imaging is a non-destructive method for diagnostics of potential heat loss problems. Thermal imaging cameras can give accurate, clear, high resolution pictures, with the ability to modify and analyze images in a detailed report. The range in thermal sensitivity is related to the price of the camera. Thermal imaging cameras capture an image of the thermal infrared light emitted from an object. That light is captured and translated into a complex temperature reading or pattern. This temperature reading goes through a process and is then translated into data that can be organized into the image. The images are analyzed to yield points of leakage or thermal loss or gain.

Both devices are expensive, require expertise in use and knowledge of application and are therefore not easy for an ordinary person to use. What is needed is a more cost effective and understandable system for evaluating energy loss in buildings.

### SUMMARY OF THE INVENTION

The present invention is a system that provides a diagnostic system to investigate and monitor energy efficiency of heated (or cooled, when air-conditioned) houses by providing a measure of the house's relative energy tightness through a yardstick defined as the Energy Tightness Factor (ETF) and for the measurement of the continuing energy efficiency of the house.

The system and related method are provided to diagnose and/or monitor energy efficiency of a building and includes a first sensor module including a first temperature sensor, wherein the first sensor module is arranged to sense temperature outside of the building, the first sensor module including a data storage component for storing therein temperature information acquired by the first temperature sensor, and a communication interface, a second sensor module including a second temperature sensor, wherein the second sensor module is arranged to sense temperature inside of the building, the second sensor module including a data storage component for storing therein temperature information acquired by the second temperature sensor, and a communication interface and a computing device configured to receive temperature information from the first sensor module and the second sensor module and to calculate: a) the delta cooling rate of the building by calculating a difference between the temperature information from the first temperature sensor and the second temperature sensor at a first time and at a second time divided by a time period defined by a difference between the first time and the second time being the duration of cooling; and b) an effective heating rate of the building by calculating a difference between the temperature information from the first temperature sensor and the second temperature sensor at a second time and at a third time divided by a time period defined by a difference between the second time and the third time being the duration of heating.

In one embodiment, the system includes standalone temperature modules, at least one outside of the building to be diagnosed and/or monitored and at least one inside the building. The standalone modules include a power supply and are configured to retain data until they are accessed for transfer of the data to the computing device. In another embodiment, the system includes temperature modules that do not retain acquired temperature information but instead transmit that information to a networked device, such as an access point for wireless radio frequency signal transmissions. The networked device, in turn, transmits the data to the computing device. The data acquired may be manipulated to compute information regarding the energy efficiency of the building and may be used to identify ways to weatherize or otherwise improve the energy tightness of the building without requiring the use of complex and/or costly sensing tools.

The corresponding method of the invention includes the acquisition of temperature information, performing calculation steps to identify the energy efficiency ratings of the building, among other things, and determine fuel savings or losses as well as heating and cooling costs. Carbon footprint information can also be determined as described herein.

These and other advantages and features of the present invention will become apparent upon review of the following detailed description, the accompanying drawings and the appended claims.

### BRIEF DESCRIPTION OF THE DRAWINGS

FIG. 1 is a basic block diagram of a Standalone Sensor Module based on a first embodiment of the present invention.

FIG. 2 is a basic block diagram of a Radio Frequency (RF) Network Sensor Module and Access Point, connected to a computing device, based on a second embodiment of the present invention.

FIG. 3 is a diagrammatic example of the placement of Standalone Sensor Module of FIG. 1 in a two-story house.

FIG. 4 is a diagrammatic example of the placement of RF Network Sensor Modules and Access Point, connected to a computing device, of FIG. 2 in a two-story house.

FIG. 5 is a block diagram of the data processing following data collection from both embodiments of the present invention as in FIGS. 1 and 2 to process and present computed information and reports.

FIG. 6 is a functional block diagram of the Standalone Sensor Module based embodiment of the present invention.

FIG. 7 is a diagram showing Data items in reference to the Standalone Sensor Module of FIG. 6.

FIG. 8 is a functional block diagram of a RF Network Module based embodiment of the present invention.

FIG. 9 is a functional block diagram of the Access Point/Data Collector used with the RF Network Module of FIG. 8 in the RF networked based embodiment of the present invention.

FIG. 10 is a diagram showing Data items in reference to acquired data as aggregated at the Access Point of FIG. 9.

FIG. 11 is a diagram showing Data acquired using the present invention in reference to the Cooling Cycle and the Heating Cycle in relation to time and the flow of data to the computation processes and output.

### DETAILED DESCRIPTION OF THE INVENTION

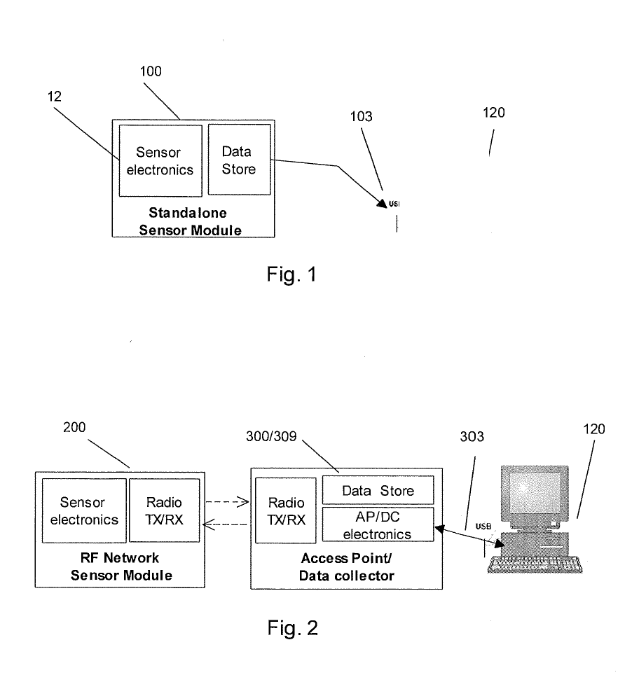

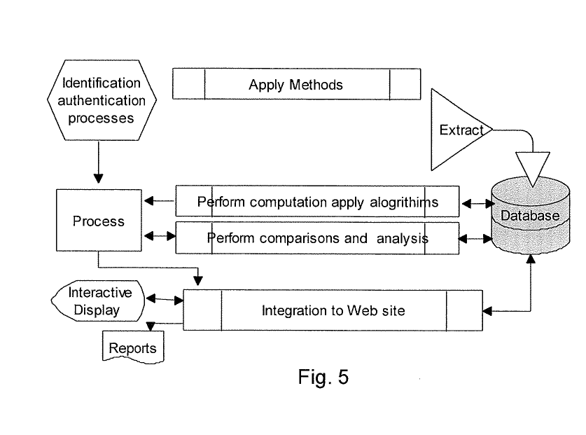

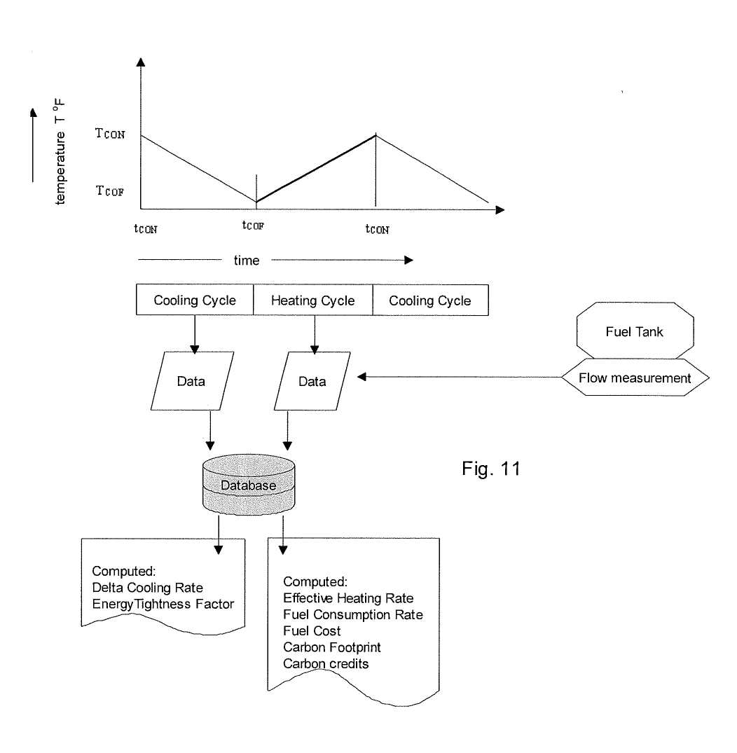

A first embodiment of the present invention is identified as a Standalone Sensor Module 100 depicted in diagrams at FIGS. 1, 3, 6 and 7, and while data processing in FIGS. 5 and 11. A second embodiment is identified as a RF Network Sensor Module 200 and Access Point system 300 depicted in diagrams at FIGS. 2, 4 and 8-10, and while data processing in FIGS. 5 and 11. The invention is therefore configured in two ways. One is the standalone version 100 with related data items shown at FIG. 7; and the second is the RF version including a RF-based sensor module 200 with means for networking via an Access Point 300 and including a Data Collector 309 such as shown at FIG. 9, with related data items shown at FIG. 10. In both cases, the same data processing environment FIG. 5 and FIG. 11 produce calculations and present reports.

In deployment, at least two of the standalone modules 100 are to be used when diagnosing the energy loss of a building 50, such as a home for example, although more than two may be used. The module may be battery powered. At a minimum, one module 100 is placed at a selected point inside a building to be monitored and one module 100 is placed outside of that building. Each of the modules 100 includes a sensor module 12 configured to independently collect specific data from the surroundings it is placed in and stores data within itself. After a prefixed collection period, all the Standalone Sensor Modules 100 are shipped to a designated lab or service facility for data retrieval and processing.

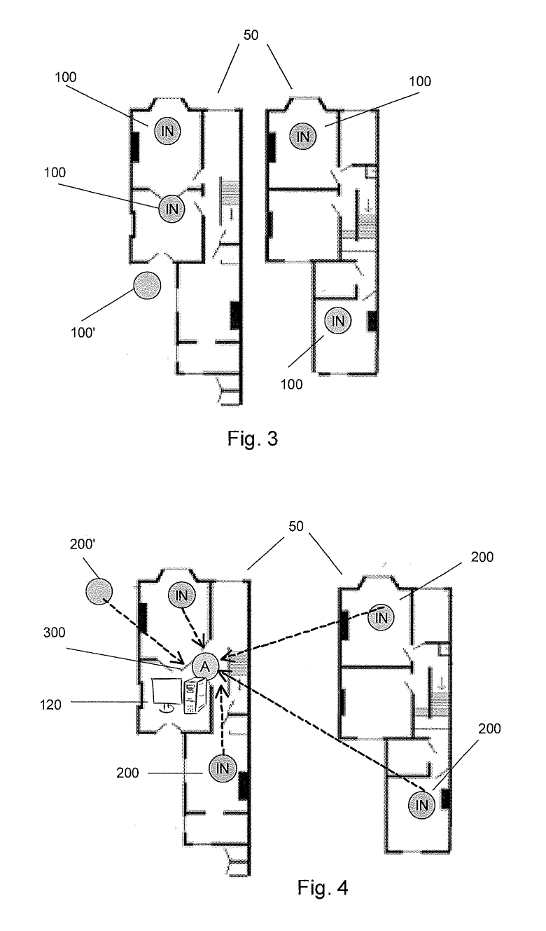

FIG. 3 shows an example of five battery-operated Standalone Sensor Modules 100 positioned within and outside of the building 50. The building 50 is depicted as a two-story home, but the present invention may be used with any other sort of structure for which an energy loss analysis is desired. The modules 100 may be powered on for use when desired by setting the on/off switch to ON and placed in different rooms, except for at least one, module 100′, which is placed outside the building 50. More than one outside module 100′ may be deployed.

With continued reference to FIG. 3, the Standalone Modules 100 that are deployed inside the building 50 should be placed in a room at about 4-5 feet above a floor toward the center of the room. They should not be placed on the floor or attached to a ceiling or placed on a window ledge, as the thermal conditions may not be representative of the typical characteristic of the inside of the room.

The outside module 100′ should be placed close to the building 50 and facing a window so that an ON designator, such as a flashing Light Emitting Diode (LED), of the Module 100′ may be observed from the building 50. The outside module 100′, used to sense outdoor temperature near the building 50, should be protected against rain or dampness and suspended at about 4-5 feet above the ground. Alternatively, the outside module 100′ may be housed in a special weatherproof housing. In all cases the outside module 100′ should be placed in a location away from any direct sunlight or erroneous data will be acquired during the day. Once all of the Modules 100/100′ are located as required, they should each be observed to confirm they are ON, such as by viewing the flashing of the LED (one flash per minute), prior to carrying out a temperature sensing process associated with a method of energy loss analysis of the present invention.

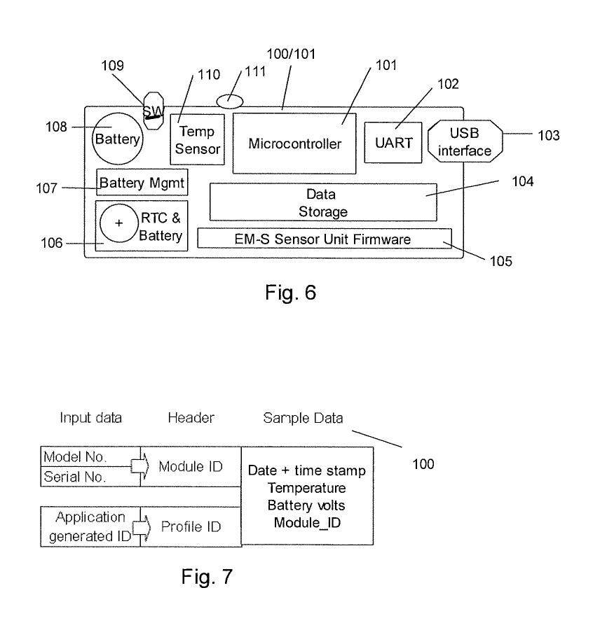

Referring now to FIGS. 6 and 7, which shows a functional block diagram of the Standalone Sensor Module 100/100′, it is to be understood that a plurality of such devices are to be configured for use during the acquisition of data associated with an energy loss diagnostic session for the building 50. Each Standalone Sensor Module 100/100′ has a unique Module_ID derived from a Model Number and a Serial Number of the Sensor Module 100/100′. At the time of shipping, the Module's Profile_ID is generated from a user's profile information and is included in a record linking the shipped Standalone Sensors' Module_IDs. These initial data items are contained in a database table set up for a user and maintained on a management system server that may be located near to or away from the sensor modules 100/100′. The Sensor Module 100/100′ is equipped with a UART 102 and USB interface 103 to enable the set up of data communications with a computing device 120, such as a personal computer, mobile computing device, mainframe computer or any other sort of device capable of storing and manipulating data and producing an output of information based on the processing of the information obtained. Communication between the Sensor Module 100/100′ and the computing device 120 may be accomplished through a communication port such as USB interface 103.

The Standalone Sensor Module 100/100′ is powered up by setting a Switch 109 to the ON position. Battery 108 powers the Sensor Module 100/100′. On powering up, a microcontroller 101, under control of Firmware 105 and execution by the microcontroller 101, commences the initialization of circuits in the Module 100/100′. The Module 100/100′ then commences acquiring sampled Data from a temperature sensor 110 (which may be in a range of about −40 F to 140 F), Battery 108 voltage, and timestamps it with internal clock circuit RTC 106 information set to Greenwich Mean Time. Acquired data is locally stored in database 104 of the Module 100/100′. The RTC circuit 106 may have its own lithium battery which is never powered off.

Examples of the main devices used in the design herein are, but not limited to the following: Texas Instruments Microcontroller series: MSP430, Numonyx Flash Ram: NAND512W, Texas Instruments Real Time clock chip: BQ32000 and Texas Instruments USB chip: TUSB 3410, and Lithium Battery: CR1032. The design is based on the Texas Instruments development system for MSP430 and the related firmware provided in the development system.

Depending on applications, records of gathered temperature data are generated at intervals of, for example in the present application, 60 seconds and stored as binary data in a nonvolatile RAM (e.g. FLASH RAM) in Data Storage 104. During each data collection event, an activity indicator LED 111 is flashed once. Under control of Battery Management 107, the Module 110/110′ then goes into standby mode and uses very low power for the following 59 seconds. At the 60^{th} second, the cycle is repeated. The cycles are repeated continuously 24 hours/day for a selectable length of time in days designated as a single monitoring session. For the present application, the Battery Management 107 enables the Sensor Module 110/110′ to run on a single battery, such as a CR1032 or 2×AAA batteries, for example, for about a year.

In general usage, at the completion of the data acquisition phase, the Switch 109 is set to OFF and the Sensor Modules 100/100′ may be packed and shipped to a designated facility that includes the computing device 120 programmed for retrieving the acquired information and processing it for desired temperature differential information.

Following termination of the data acquisition phase, the Modules 100/100′ are connected to the computing device 120 used to store and manipulate the data. The computing device 120 detects the Sensor Module 100 as a removable storage device. The computing device 120 is also configured to be connected to the Internet and runs an Application Program [EM-S APP] that reads the sampled Data and Module_ID from the Sensor Module 100/100′ via the USB interface 103 into a database in the computing device 120 that will hold the time stamped records from all the Sensors 110 used in the configuration for each Profile_ID. On manual batch acquisition of data from all the Sensor Modules 100, the data is uploaded to a primary database, which may be a single main database or a set of databases. A Management Systems Server of the computing device 120, or in communication with the computing device 120, may be used for that purpose. By this process, a table of relevant sensed data for the building 50, as well as other buildings, may be populated and updated as data are acquired. The data of the table is associated with the Profile_ID. The data associated with a single measurement session is referenced to a Session_ID. From the collected data, the Cooling ON (Heating OFF) and Cooling OFF (Heating ON) cycles are identified in real-time and selected for retrieval of recorded data for analytical use in report generation.

At the completion of data upload to the Management Systems Server, the local database and the Sensor's sampled Data in the data storage 104 and the Central Database are synchronized with time data converted to local time based on the telephone Area code and/or the ZIP code or Postal code recorded in the Profile data of the User keyed to the Profile_ID. On data synchronization, a flag is set in the Sensor Module 100/100′ to enable the overwriting of the data storage 104 with new data for reuse. The Sensor modules 100 can then be used in a new monitoring session with another or the same Profile_ID.

FIG. 2 shows the configuration of the RF version of the invention including the RF-based sensor module 200 with means for networking via the Access Point 300 in relation to the Access Data Collector 309 and the computing device 120. In deployment shown in FIG. 4, the battery-powered RF Network Sensor Modules (designated as 200 for inside Modules and 200′ for outside Modules) are placed in the various rooms of the building 50. They have a signal exchange connection to the Data Collector 309 through the Access Point 300 by way of a RF signal exchange standard commonly used in wireless signal exchanges systems of networks. The Access Point 300 is connected to the computing device 120 at USB port 303 (or to an AC adaptor for offline monitoring).

FIG. 4 shows an example of five battery-operated RF Network Sensor Modules 200/200′, one Access Point 300/Data Collector 309 connectable to the computing device 120, with each RF Network Sensor module 200/200′ powered on by setting the on/off switch to ON and being placed the in the different rooms (modules 200) and one outside (module 200′). The RF networked Modules 200 that are deployed inside the building 50 should be placed in a room at about 4-5 feet above the floor toward the center of a room. They should not be placed on the floor or attached to the ceiling or a placed on a window ledge as the thermal conditions may not be representative of the typical characteristic of the inside of the room. The outside Module 200′ should be placed close to the building 50 and facing a window so that the flashing LED in the Module 200′ may be observed from the building 50. The Module 200′ should be protected against rain or dampness and it should be suspended 4-5 feet above the ground. Alternatively, the Module 200′ may be housed in a special weatherproof housing. The Module 200′ should be placed in a location away from any direct sunlight or erroneous data will be acquired during the day.

Once all the Modules 200/200′ are located where suitable, it is useful to verify and observe that all the Modules 200/200′ are displayed as active by the flashing of the LED (one flash per minute) on each Module, and the computer program that may be accessed through the computing device 120 that is network connected to the Access Point 300 is used to verify and observe that all the Modules 200/200′ are displayed as active on a visual display associated with the computing device 120. In an embodiment of the invention, the computing device 120 may be configured to enable a continuous display of the temperature information sensed at each Module 200/200′. If any of the Modules 200/200′ is not shown as displayed, it may be an indication that the RF signal exchange is not complete and should be evaluated and resolved before data are gathered.

The RF networked embodiment of the invention preferably involves the use of two or more identical RF networked, battery powered, RF network enabled Sensor Modules 200/200′ to automatically transmit the data continuously to the Access Point 300, which may be locally centrally located so as to exchange signals with all of the Modules 200/200′, although multiple Access Points 300 may be required as a function of the number and spacing of the Modules 200/200′ and/or the building environment. The Access Point 300 collects data from all of the RF Sensor Modules 200/200′ in the local RF network. The Access Point 300 and its associated Data Collector 309 accumulate and store data transferred from all of the RF Sensor Modules 200/200′ within its range of communication. The Access Point 300 is attached to the computing device 120 via the USB interface 303. The Access Point 300 can work in an offline mode with an AC adaptor or when the computing device 120 is in standby mode (USB power is ON). In all cases, all the Modules 200/200′ associated with the building 50 must remain powered up during an initial startup testing period together with the Access Point 300. When the computing device 120 is on and configured for data signal exchange with the Access Point 300, the Access Point 300 transfers on demand or in a defined manner, data stored therein to the computing device 120. The accumulated data is then subsequently either stored and/or manipulated at the computing device 120, the computing device 120 connected to the Internet transfers it to a remotely located Management System server or a combination of the two. The data may be stored in a centralized Database of the Management System for post processing and reporting.

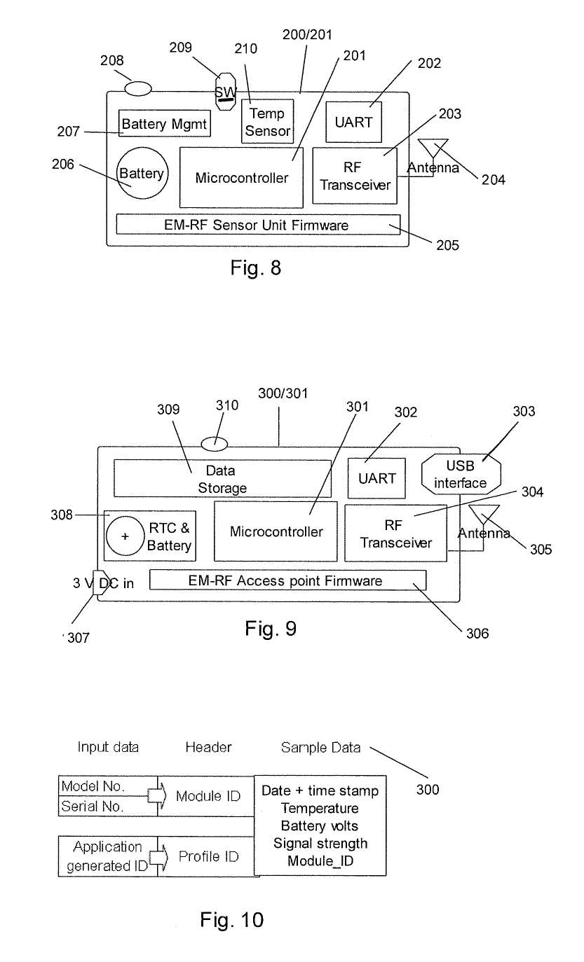

FIG. 8 shows the functional block diagram of the working of one RF Sensor Module 200/200′, a multiple number of which are configured for use when networked to an Access Point 300/Data Collector 309 during the data acquisition session as previously indicated. With reference to FIG. 10, each RF Sensor Module 200/200′ has a unique Module_ID derived from the Model Number and Serial Number of the Sensor Module 200/200′. At initial set up time, the Module's Profile_ID is generated with the USER's profile information and is included in records linking the networked RF Sensors' Module_IDs. The initial data items are contained in a local database table set up in a USER's computing device 120 and, optionally, synchronized with the Central Database on the Management System server.

The RF sensor Module 200 is powered up by setting the Switch 209 to the ON position. The Battery 206 powers the RF Sensor Module 200. On powering up, a microcontroller 201, under control of RF Sensor Firmware 205 and execution by the microcontroller 201, commences the initialization of circuits in the Module 200/200′. The Module 200/200′ then commences acquiring sampled Data from the temperature sensor 210, which may be provided in a form that can measure temperature in a range of about −40 F to 140 F, Battery 206 voltage, Signal Strength and coupling it with its originating Module_ID, transmits it to the Access Point 300/Data Collector 309 via RF Transceiver 203 and Antenna 204.

Example of the main devices used in the design herein are, but not limited to, the following: Texas Instruments Microcontroller series: MSP430, Numonyx Flash Ram: NAND512W, Texas Instruments Real Time clock chip: BQ32000 and Texas Instruments USB chip: TUSB 3410, Texas Instruments CC2500 series RF radio chip and Lithium Battery: CR1032. The design is based on the Texas Instruments development system for eZ430-RF2500 including the related firmware and RF network provided in the development system.

The Data from the RF sensor Modules 200/200′ are transmitted at intervals of 60 seconds in this application, although the invention is not limited to such a specific sensing interval and others may be selected. During the data transmission time, an activity indicator LED 208 is flashed once. Under control of the Battery Management 207, the RF Sensor Module 200/200′ then goes into standby mode and uses very low power for the following 59 seconds. At the 60^{th} second the cycle is repeated. The cycles are repeated continuously 24 hours/day for the required length of time in days for a single monitoring session. The Battery Management 207 enables the RF Sensor Module 200/200′ to run on a single battery like a CR1032 or 2×AAA, for example, for more than six months depending on the transmitter power.

FIG. 9 shows a functional block diagram of the working of an example Access Point 300 with Data Collector 309 where the data from the RF Sensor Modules 200/200′ is transmitted by the Modules 200/200′ and received at the Access Point 300 via Antenna 305 to RF Transceiver 304. Under control of Access Point Firmware 306 and execution by microcontroller 301, each record thus received is time stamped with RTC 308 information set to Greenwich Mean Time. The RTC 308 circuit has its own lithium battery which is never powered off Switch 310 is a power ON/OFF/RESET switch. The Access Point 300 is equipped with a UART 302 and the USB interface 303 to enable the set up of data communications with the computing device 120. The computing device 120 detects the Access Point 300 as a removable storage device.

The records from all the RF Sensor Modules 200/200′ in the network associated with the building 50 are transmitted at intervals of 60 seconds and stored as binary data in a nonvolatile RAM (e.g. FLASH RAM) in the Data Collector 309. The computing device 120 may be connected to the Internet and configured to run a computer program [EM-RF APP] that aggregates the sampled Data from all the participating RF Sensor Modules 200/200′ in the network into a local database that will hold the time stamped records from all the Modules 200/200′ used in the configuration for each Profile_ID. When online, the acquired data from all the RF Sensor Modules 200/200′ is uploaded in real time to the Central Database on the Management System Server. By this process the local database updates and populates the prior database tables associated with the Profile_ID.

In any powered mode, whether the Access Point 300 is powered from the computing device 120 in standby mode via the USB connector 303 or an power-line AC adapter plugged in DC-in jack 307 the RTC 308 in the Access Point 300 continues to provide the time stamp information for each incoming data record received at the Access Point 300. Whenever the Access Point 300 is connected to the USB connector 303, under application program control and connected to the Internet, the acquired data from all the RF sensor Modules 200/200′, now stored in the Access Point 300, is uploaded to the Central Database on the Management System Server. The data associated with a single measurement session is referenced to a Session_ID. From the collected data, the Cooling ON (Heating OFF) and Cooling OFF (Heating ON) cycles are identified in real-time and selected for retrieval of recorded data for analytical use in report generation.

At the completion of data upload to the Management System Server, the local database of the computing device 120 and the Sensor's sampled Data in the data storage 309 and the Central Database are synchronized with time data converted to local time based on the telephone Area code and/or the ZIP code or Postal code recorded in the Profile data of the User keyed to the Profile_ID. On data synchronization a flag is set in the Access Point 300/Data storage 309 to enable the overwriting of the storage area with new data for reuse. The Access Point 300 can then be used in a new monitoring session with the Sensor Modules 200/200′ with another or the same Profile_ID.

### Definitions

The following are definitions of terms or descriptors used herein with respect to houses heated when the Outside Temperature is colder than is normally considered comfortable. (The definitions may be restructured appropriately, when the heat flow is in the reverse direction, when the said systems are used in an air-conditioned house, with a hotter than is normally considered comfortable Outside Temperature). The temperature measurement is not limited to ° F. and the computations may be set for reporting as, in the US, ° F. (degree Fahrenheit) or ° C. (the metric degree Celsius or Centigrade).

Energy Tightness Factor (ETF): Energy Tightness Factor is a pure number defined as the ratio of the computed Energy Tightness of a Target House to the computed Energy Tightness of a Standard House at a specific Outside Temperature. The ETF of a Standard House compared with the ETF of a reference Standard House should yield a number with a dimension approaching or equal to 1.

Standard House: a house constructed to predefined standards issued by a State or governing body which describes the codes and prescribes the specifications of construction materials and construction practice to meet a desired level of energy efficiency; example: homes meeting guidelines for energy efficiency set by the U.S. Environmental Protection Agency or homes built to the 2004 International Residential Code (IRC) and the like. The State or a related authority may institute newer standards from time to time and each time the Standard House ETF is upgraded to the current value in the system for the territory applicable.

Target House: a house under measurement using the diagnostic and monitoring system of the present invention.

Cooling Cycle: the duration in time when the heating is turned off and the house or room undergoes a natural cooling though heat loss.

Delta Cooling Rate (DCR) is defined as the rate of loss of heat during a Cooling Cycle in a target container (room of house) under measurement. It is the difference between the room temperatures at the start of a Cooling Cycle and at the end of that Cooling Cycle divided by the time duration of the Cooling Cycle at a specific Outside Temperature. It is reported as ° F. per minute (° F./Min).

Outside Temperature: the temperature outside the house that establishes a temperature differential between the inside and outside temperature.

Heat-loss Cycle: same as Cooling Cycle.

Heating Cycle: the duration which the heating system kicks in to establish the desired preset inside room temperature. It is also the duration between the end of one Cooling Cycle and the start of the next Cooling Cycle.

Effective Heating Rate (EHR): is defined as the rate of increase of temperature during a Heating Cycle in a target container (room of house) under measurement. It is the difference between the room temperatures at the start of a Heating Cycle (=end of Cooling Cycle) and at the end of that Heating Cycle (=start of Cooling Cycle) divided by the time duration of the Heating Cycle at a specific Outside Temperature. It is reported as ° F. per minute (° F./Min). It is the effective rate of heating resulting from the heating system working against the Delta Cooling Rate (DCR) to establish the rise in temperature to the preset limit set at the thermostat in the house.

Fuel Consumption Rate (FCR) is the rate of consumption of a fuel in gallons/year or liters/year in case of heating oil. (Monthly FCR [MFCR] may also be reported in gallons/month or liters/month if flow measurements are used)

Module_ID: a unique identifier for each Module.

Session_ID: a unique identifier for a measurement session initiated each time the power switch of a Module is turn ON.

Profile_ID: a unique identifier for all data related to a particular house/user.

An example of the use of the system of the present invention is provided herein. It is to be understood that this is one example and involves only the evaluation of temperature differentials inside and outside a building to be diagnosed for energy loss. It includes several steps executed through the software applications with reference to FIG. 11.

Computation of ETF

General Naming of Parameters

T_{CON}—Temperature in Room 1 (° F.) at start of Cooling Cycle

### T_{COF}—Temperature in Room 1 (° F.) at end of Cooling Cycle

### T_{RN}—Temperature in Room N (° F.)

### Tₒᵤₜ—Temperature Outside (° F.)

t_{CON}—time Cooling Cycle starts (CON)=cycle start time
t_{COF}—time Cooling Cycle is turned off (COF)=cycle end time
T_{R1}−T_{OUT}=Temperature difference between inside Room 1 and outside (° F.)

Assumptions: For the purpose of the measurement sessions the room temperature value at thermostat is set at 70° F.

To establish baseline data and ETF, steps 1-7 may be carried out before weatherization and retrofits.
Steps 1-7 may be subsequently carried out after weatherization and retrofits to record dat on improvements and continuing ETF.

Step 1—Determination of t_{CON} and T_{CON} (Start of Cooling Cycle)

From data tables to determine start of Cooling Cycle (=end of a Heating Cycle)
Subtract value of previous T_{R1} reading from current value of T_{R1} reading till difference turns negative by 0.1° F. and maintains a decreasing trend.
Select center value of T_{R1} between the two time stamps with a difference that is negative by 0.1° F.=T_{CON}
Select corresponding center value of time between the points where the value of temperature difference is negative by 0.1° F.=t_{CON}.

Step 2—Determination of t_{OFF} and T_{COF} (End of Cooling Cycle)

From data tables to determine end of Cooling Cycle (=start of Heating Cycle)
Subtract value of previous T_{R1} reading from current value of T_{R1} reading till difference turns positive by 0.1° F. and maintains an increasing trend.

Select center value of T_{R1} between the two time stamps with a difference of 0.1° F.=T_{COF}

Select corresponding center value of time between the points where the value of temperature difference is positive by 0.1° F.=t_{COF}

Step 3—Compute Delta Cooling Rate (DCR) at each value of Outside Temperature (Tₒᵤₜ)

### Compute:

T_{CON}−T_{COF}=Temperature difference at start and end of Cooling Cycle

t_{CON}−t_{COF}=time duration of Cooling Cycle

(T_{CON}−T_{COF})/(t_{CON}−t_{COF})=rate of cooling ° F./minute=Delta Cooling Rate(DCR)@Tₒᵤₜ

Step 4—Table of Values of DCR of Target House

Compute/Populate table for DCR for complete Outside Temperature range whatever possible between −40° F. and 140° F.

Step 5—from Database: Plot House Characteristics/Graphs

Select data/Plot DCR versus Outside Temperature to get cooling characteristic curves for house

Step 6—Compare with DCR Data Tables on Reference Standard House in Database

From database retrieve DCR data of Standard House at specific Outside Temperatures for comparison of same data fields tabled at Step 4.

Step 7—Determine ETF and Median Value of ETF

Divide DCR of Target House by DCR of Standard House at each value of Outside Temperature to get ETF at that Outside Temperature. Create table. Determine the median value of ETF.

Step 8—Determine Value of Energy Star Rating

Multiply the median value of the Target House ETF by the value of Energy Star rating of Standard House to get Energy Star rating or the thermal performance of the Target house. The invention herein does not rate a house with an Energy Star rating as specified by the EPA. To provide further explanation: Through a Partnership Agreement with U.S. Environmental Protection Agency (EPA), a builder agrees to affix an Energy Star label on homes that are independently verified to meet program guidelines. To ensure that a home meets Energy Star guidelines, third-party verification by a certified Home Energy Rater (or equivalent) is required. This Rater works closely with the builder throughout the construction process to help determine the needed energy-saving equipment and construction techniques and conduct required on-site diagnostic testing and inspections to document that the home is eligible to earn the Energy Star label. After the Rater completes the final inspection and determines that all requirements have been met, the Rater will provide the builder with an Energy Star label, which is placed on the circuit breaker box of the home. This label provides the homeowner with documentation that the home is Energy Star qualified, and includes the home address, builder name, Rater name, and date verified. Some builders may also provide a paper certificate or copy of the Home Energy Rating report. For the purpose of the ETF calculation such an Energy Star qualified house may be considered as the “Standard House” as defined herein. Therefore the ETF of the house under measurement may be computed, in dimensional value, based on the DCR of such a Standard House. The multiplication of the ETF by the Energy Star rating of the Standard House may therefore provide a simplified comparison in thermal loss performance to a value similar to the Energy Star rating of the house under measurement.

Computation of Effective Heating Rate (EHR) and Effective Heating Factor (EHF)

Assumptions: For the purpose of the measurement sessions the room temperature value at thermostat is set at 70° F.

For the EHF computation the heating system output is assumed to be unchanged before and after weatherization.

General Naming of Parameters

T_{COF}—Temperature in Room 1 (° F.) at start of Heating Cycle

### Next T_{CON}—Temperature in Room 1 (° F.) at end of Heating Cycle

### T_{R1}—Temperature in Room 1 (° F.)

### T_{RN}—Temperature in Room N (° F.)

### Tₒᵤₜ—Temperature Outside (° F.)

t_{COF}—time Heating Cycle starts (=Cooling Cycle is turned (COF)=cycle end time
Next t_{CON}—time Heating Cycle ends (=next Cooling Cycle starts) (CON)=cycle start time
T_{R1}−T_{OUT}=Temperature difference between inside Room and outside (° F.)

Computation of Effective Heating Rate (EHR) at each value of Outside Temperature (Tₒᵤₜ)

The values of T_{COF}, Next T_{CON}, t_{COF}, and Next t_{CON} are established using the same principles as described at [0064] and [0065]
T_{COF}—next T_{CON}=Temperature difference between start and end of Heating Cycle
t_{COF}—next t_{CON}=Time duration of Heating Cycle

### Calculate:

T_{COF}−Next T_{CON})/(t_{COF}−Next t_{CON})=Effective Heating Rate(EHR) in ° F./minute@Tₒᵤₜ

Step 1—Establish data at baseline before (pre) weatherization or retrofits and compute EHR for a range of Tₒᵤₜ using process as at [0075]=EHRpre

Step 2—Monitor data after (post) weatherization or retrofits and compute EHR for a range of Tₒᵤₜ using process as at [0075]=EHRpost

Compute Effective Heating Factor (EHF) at Each Value of Outside Temperature (Tₒᵤₜ) and Median Value of EHF

### Calculate:

EHRpost/EHRpre=Effective Heating Factor(EHF) at each value of Tₒᵤₜ Median value of EHF

From Database: Plot House Characteristics/Graphs for EHR & EHF

Plot EHR versus each value of Outside Temperature to get heating characteristic curves for house.
Plot EHF versus each value of Outside Temperature to get heating characteristic curves for house.

Computing Savings in Fuel Consumption/Cost and Carbon Footprint

Fuel consumption saving is based on user provided data. The usefulness of this computation is based entirely on the accuracy of historical fuel consumption information provided by the user for the house under measurement.
Step 1—User inputs annual prior fuel (accurate estimation or actual) consumption data at baseline (before weatherization or retrofits)=FCRpre=Annual fuel consumption, in gallons.
Step 2—Get current year fuel consumption data from monitored data after (post) weatherization or retrofits) as follows:

Median value of EHF×FCRpre=prorated consumption based on EHF characteristic of house=FCRpost

(FCRpre−FCRpost)=Saving in Fuel consumption in gallons

[(FCRpre−FCRpost)/FCRpre]×100=% Saving in Fuel Consumption

Annual Carbon footprint reduction=Saving in Fuel Consumption in gallons×Carbon conversion rate

Annual fuel cost saving in $=Saving in Fuel Consumption in gallons×average Fuel oil price ($/Gallon) over period.

Computing Savings in Fuel Consumption/Cost and Carbon Footprint—Alternate Method with Flow Meter Data

Fuel consumption saving is based on user provided data. The usefulness of this computation is based on the accuracy of historical fuel consumption information provided by the user for the house under measurement.

From Flowmeter Data:

Step 1—Get prior fuel (actual) annual consumption data at baseline before weatherization or retrofits=FCRpre=Annual fuel consumption.
(Flowmeter Fuel Consumption recorded/computed to gallons per year or liters per year).
Step 2—Get current actual annual fuel consumption data from monitoring after (post) weatherization or retrofits=FCRpost.

(FCRpre−FCRpost)=Saving in Fuel consumption in gallons

[(FCRpre−FCRpost)/FCRpre]×100=% Saving in Fuel Consumption

Annual Carbon footprint reduction=Saving in Fuel Consumption in gallons×Carbon conversion rate

Annual fuel cost saving in $=Saving in Fuel Consumption in gallons×average Fuel oil price ($/Gallon) over period.

The system of the present invention is a set of functions embodied in computing means for executing the primary actions associated with the method described herein. It is to be understood that the computing device represented as computing device 120 is a representation of computing means suitable for executing the functions of the system. The computing device shown is only one example of a suitable computing means and is not intended to suggest any limitation as to the scope of use or functionality of the invention. For example, the computing device 120 may be associated with local or remote computing means, such as one or more central computers, such as the management system server described herein of a local area network, a metropolitan area network, a wide area network, or through intranet and internet connections.

The computing device 120 may include one or more discrete computer processor devices. Additional examples of well known computing means that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing or cloud computing environments that include any of the above systems or devices, and the like. The computing device 120 may include computer devices operated by one or more users, such as through a desktop, laptop, or servers, under their respective operating systems, for example and not limited to any versions of MacOS, Linux, Unix, Windows or the like, and/or one or more providers of services corresponding to one or more functions of the invention.

The server, the computer processor, or a combination of both may be programmed to include one or more of the functions of the invention system. One or more databases represented by the database of FIG. 11 that may be associated with the server, the computer processor, other computing devices, or any combination thereof, include information related to the use of the invention system. For example, the database may include information of importance to the user. The database may be populated and updated with information provided by an application provider capable of carrying out one or more of the steps associated with the system of the invention, one or more businesses, or any other information providers. All of the devices may be interconnected through one or more signal exchange devices.

The functions of the invention described herein with respect to the computing device 120 may be described in the general context of computer-executable instructions, such as program modules, being executed by a computer. Generally, program modules include routines, programs, objects, components, data structures, etc. that perform particular tasks or implement particular abstract data types. As indicated above, the system of the present invention may also be practiced in distributed computing environments where tasks are performed by remote processing devices that are linked through a communications network or other data transmission medium. In a distributed computing environment, program function modules and other data may be located in both local and remote computer storage media including memory storage devices.

The computer processor and interactive drives, memory storage devices, databases and peripherals may be interconnected through one or more computer system buses. The system buses may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computer system that may be the computing device 120 or that may include the computing device 120 typically includes a variety of computer readable media. Computer readable media can be any available media that can be accessed by the computer system and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer system.

The computer system further includes computer storage media in the form of volatile and/or non-volatile memory such as Read Only Memory (ROM) and Random Access Memory (RAM). RAM typically contains data and/or program modules that are accessible to and/or operated on by a computer processor. That is, RAM may include application programs, such as the calculation functions of the system of the present invention, and information in the form of data. The computer system may also include other removable/non-removable, volatile/non-volatile computer storage and access media. For example, the computer system may include a hard disk drive or solid state drive to read from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the computer system to perform the functional steps associated with the system and method of the present invention include, but are not limited to, magnetic tape cassettes, flash memory cards, digital versatile disks, digital video tape, solid state RAM, solid state ROM, and the like.

The drives and their associated computer storage media described above provide storage of computer readable instructions, data structures, program modules and other data for the computer processor. A user may enter commands and information into the computer processor through input devices such as keyboards and pointing devices, commonly referred to as a mouse, trackball or touch pad or touch screen. Other input devices may include a microphone, joystick, game pad, satellite dish, scanner, or the like. These and other input devices are connected to the computer processor through the system bus, or other bus structures, such as a parallel port, game port or a universal serial bus (USB), but is not limited thereto. A monitor or other type of display device is also connected to the computer processor through the system bus or other bus arrangement. In addition to the monitor, the computer processor may be connected to other peripheral output devices, such as printers.

The computer processor may be configured and arranged to perform functions and steps embodied in computer instructions stored and accessed in any one or more of the manners described. The functions and steps, such as the functions and steps of the present invention described herein, individually or in combination, may be implemented as a computer program product tangibly as computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by the computer processor, instruct the computer processor to perform one or more processes or acts described herein, and/or various examples, variations and combinations thereof. Such instructions may be written in any of a plurality of programming languages, for example, Java, Visual Basic, C, or C++, FORTRAN, Pascal, Eiffel, Basic, COBOL, XML, HTML and the like, or any of a variety of combinations thereof. Furthermore all such programming may be integrated to eventual delivery of information and computed results via web pages delivered over the internets, intranets, 3G, 4G or evolving networks to computing devices including those in the mobile environment, for example, Smartphones or iPhone, iPad and the like or any variety of combinations thereof.

All the data aggregated and stored in the database or databases may be managed under an RDBMS for example Oracle, MySQL, Access, PostgreSQL and the like or any of a variety of combinations thereof. The RDBMS may interface with any web based or program driven applications written in any compatible programming languages including PHP, HTML, XML, Java, AJAX and the like or any of a variety of combinations thereof. The computer-readable medium on which such instructions are stored may reside on one or more of the components described above and may be distributed across one or more such components.

The present invention as described is a system and related method for diagnosing and monitoring building energy efficiency. The invention has been described with specific reference to certain system configurations and method steps including a computing system configured to perform the actions described. The invention is not limited to the specific arrangements and steps described herein. All equivalents are deemed to be within the scope of the invention as described by the following claims.

What is claimed is:

1. A system to diagnose and/or monitor energy efficiency of a building, the system comprising:
a. a first sensor module including a first temperature sensor, wherein the first sensor module is arranged to sense temperature outside of the building, the first sensor module including a data storage component for storing therein temperature information acquired by the first temperature sensor, and a communication interface;
b. a second sensor module including a second temperature sensor, wherein the second sensor module is arranged to sense temperature inside of the building, the second sensor module including a data storage component for storing therein temperature information acquired by the second temperature sensor, and a communication interface; and
c. a computing device configured to receive temperature information from the first sensor module and the second sensor module and to calculate:
i. a Cooling Rate of the building by calculating a difference between the temperature information from the second temperature sensor at a first time and at a second time divided by a time period defined by a difference between the first time and the second time; and
ii. an Effective Heating Rate of the building by calculating a difference between the temperature information from the second temperature sensor at a second time and at a third time divided by a time period difference between the second time and the third time.

2. The system of claim 1 further comprising a data acquisition system that dates and time stamps each data item collected integrated to a unique embedded device identifier (Module_ID).

3. The system of claim 2 further comprising a Central Database into which all temperature and other information data collected under each Module_ID is aggregated under a user data table key using a Profile_ID with each separate data acquisition session from a Module_ID identified by a Session_ID.

4. The system of claim 3 further comprising a computer program executable on the computing device to manage data acquisition and uploading of collected data to the Central Database keyed to the Profile_ID.

5. The system of claim 1 wherein the computing device is configured to compute Energy Tightness Factor, effective heating factor, fuel consumption, savings in fuel consumption, carbon footprint reduction and the Energy Star rating for the building based on the temperature information acquired with the first temperature sensor and the second temperature sensor.

6. The system of claim 5 wherein the computing device is configured to compute the Energy Tightness Factor of the building based on a Cooling Rate for a standardized building and the Cooling Rate of the building under measurement by the system.

7. The system of claim 6 wherein the Energy Tightness Factor is the reported result of the energy efficiency of the building measured by the system.

8. The system of claim 6 wherein data from the building is uploaded to a database and is subject to a computation based on historical reference data previously aggregated from specific standardized buildings.

9. The system of claim 1 where the temperature at a start of a cooling cycle used to determine the Cooling Rate is computed from collected time-stamped data to be a midway point of a duration in time at which the temperature decreases by 0.1 F and maintaining a decreasing trend, and a temperature at the end of the cooling cycle to be the midway point of the duration in time at which the temperature increases by 0.1 F and maintaining an increasing trend as input to a Delta Cooling Rate (DCR) computation, and the temperature at a start of a heating cycle used to determine the Effective Heating Rate is computed from collected time-stamped data to be a midway point of a duration in time at which the temperature increases by OAF and maintaining an increasing trend, and a temperature at the end of the heating cycle to be the midway point of the duration in time at which the temperature decreases by 0.1 F and maintaining a decreasing trend as input to the DCR computation.

10. The system of claim 6 wherein the time at the start of the cooling cycle is correlated to the computed temperature at the start of the cooling cycle and the time at the end of the cooling cycle is correlated to the computed temperature at the end of the cooling cycle as input to a Delta Cooling Rate (DCR) computation.

11. The system of claim 10 wherein the DCR is computed as the numeric value of the change in temperature between the start and the end of the cooling cycle divided by the time duration of the cooling cycle.

12. The system of claim 1 configured to determine the Energy Tightness Factor and the Effective Heating Rate when a heating or cooling system of the building is operational and set to maintain a desired indoor temperature.

13. The system of claim 1 wherein the communication interface of the first sensor module and the communication interface of the second sensor module are Radio Frequency (RF) communication devices, the system further comprising an access point to receive the temperature and other information from the first temperature sensor module and the second temperature sensor module, and to transmit the temperature and other information to the computing device.

14. The system of claim 13 wherein temperature information is collected in a data collector of the access point rather than in the data storage components of the first sensor module and the second sensor module.

15. The system of claim 14 wherein data storage within the access point and the standalone sensor modules can be overwritten only after the temperature information of the first sensor module and the second sensor module data have been synchronized with a database of the computing device.

16. The system of claim 1 configured to compute the effective heating rate before and after weatherization of the building and report a heating efficiency factor of the building corresponding to a saving in fuel consumed in the building before and after weatherization.

17. The system of claim 1 further comprising one or more flow sensors to acquire data relating to fuel flow to a heating furnace for determination of Fuel Consumption Rate (FCR) for the heating furnace.

18. The system of claim 17 wherein the difference in the computed FCR before and after weatherization of the building (FCRpre—FCRpost) is divided by the FCR determined before weatherization (FCRpre) to enable generation of a report of a saving in fuel consumption and correlated to a computation of saving in fuel cost achieved in the building after weatherization.

19. The system of claim 18 wherein the reduction in carbon emission after weatherization is computed by multiplying the saving in fuel consumption by a carbon conversion factor to report a decrease in the carbon emission.

20. The system of claim 6 wherein the energy efficiency of the building measured by the system as the median value of Energy Tightness Factor is also subsequently multiplied by the value of Energy Star rating of the standard building used in that computation to yield a value of Energy Star rating for the thermal performance of the building under test.
